(19) United States
(12) Patent Application Publication
(10) Pub. No.: US 2026/0243031 A1
(43) Pub. Date: Aug. 20, 2026

(54) WATER LAMINATED TISSUE PRODUCTS

(71) Applicant: Kimberly-Clark Worldwide, Inc., Neenah, WI (US)

(72) Inventors: Giulia Silvestri, Novara (IT); Massimo Cagnone, Prato Sesia (IT); Giovanni Massarotti, Novara (IT)

(21) Appl. No.: 19/490,645

(22) PCT Filed: Apr. 24, 2024
(86) PCT No.: PCT/US2024/025929

§ 371 Date: Dec. 5, 2025

Related U.S. Application Data
(60) Provisional application No. 63/462,543, filed on Apr. 28, 2023.

(51) Int. Cl. D21H 27/40; B31F 1/07; B31F 1/36; D21H 27/00; D21H 27/02

(52) U.S. Cl. CPC D21H 27/40; B31F 1/07; B31F 1/36; D21H 27/002; D21H 27/02; B31F 2201/0723; B31F 2201/0733; B31F 2201/0789

(57) ABSTRACT

The invention relates to multi-ply embossed tissue products, and methods of manufacturing the same, that are laminated without the use of an adhesive. Rather than rely about an adhesive to laminate the plies to one another, the embossed tissue products comprise a non-adhesive aqueous composition, which is applied to one of the tissue plies prior to, or immediately after, the ply is embossed and thereby increases the basis weight of the tissue ply from about 1% to about 10%. The wetted tissue ply is at least partially dried by contacting the wetted tissue ply with a first heatable embossing roll, which forms a part of the embossing nip. Drying of the wetted web by the first heatable embossing roll causes the embossed tissue ply to have a basis weight that is less than that of the wetted tissue ply. After wetting and at least partially drying, the first tissue ply may be laminated to a second tissue ply by passing the two plies thought a second nip and joining them together without the use of an adhesive.

### BACKGROUND

It is well known in the art to emboss bond multiple plies of lightweight cellulosic material to form tissue products such as bath tissues, facial tissues, paper towels, industrial wipers, foodservice wipers, napkins, medical pads, and other similar products. The embossed tissue products may comprise one, two, three or more plies. Embossing not only plies multiple tissue plies together but may also impart the tissue product with an aesthetically pleasing pattern. Examples of apparatus and methods for embossing multi-ply paper products are disclosed, for example, in U.S. Pat. Nos. 6,733,866, 7,871,692 and 8,287,986 and U.S. Publication No. 2012/0156447.

Embossing may also be used to alter or improve certain tissue product properties such as sheet bulk and perceived softness. For example, tissue products manufactured using conventional creped wet press technology can be embossed subsequent to creping to improve bulk and perceived softness. Embossing often increases the surface area of the sheets by introducing a plurality of protuberances and thereby enhances the bulk and handfeel of the product. Examples of apparatus and methods for embossing multi-ply paper products to improve handfeel and bulk are disclosed, for example, in U.S. Publication Nos. 2005/0103456, 2018/0142422 and 2018/0135254.

To further enhance the bulk and handfeel of the embossed tissue product, embossing and lamination may be carried out by heating one or more of the tissue plies during the embossing and lamination process. For example, U.S. Publication No. 2020/0324506 describes an embossing and lamination process that utilizes a wetting unit and a hot paper micro-embossing device. The individual paper plies are wetted and hot micro-embossed and then fed to a traditional embossing and glue lamination device, comprising two pairs of rubber/steel rolls and a glue dispenser. In another example, U.S. Publication No. 2020/0384718 discloses an embossing and lamination assembly having a heating means for heating one of the steel embossing rolls to a temperature between about 100° C. and 200° C. The heated steel embossing abuts the adhesive delivery assembly on one side and the marrying roll on another such that adhesive is added to the heated, embossed sheet before being plied at the marrying roll.

While heating the tissue during the embossing process may enhance the bulk and handfeel of the resulting tissue product, the process is not compatible with traditional adhesive lamination process, which commonly rely upon water-soluble adhesives such as water-soluble latex to bond the sheets together. Because embossing and lamination are commonly carried out in the same or successive steps, heating of the tissue ply causes rapid evaporation of water from the adhesive and the rapid build-up of tacky residue on machinery.

Heating the tissue ply during the embossing process may also cause excessive strength degradation to the tissue ply, particularly if the tissue is not moistened prior to embossing. Thus, water may be applied to the tissue prior to passing through the embossing nip. Unfortunately, prewetting of the tissue ply followed by the addition of a water-soluble adhesive may cause excessive wetting of the tissue causing excessive elongation and rupture as it passes through the embossing nip.

Thus, there remains a need in the art for an embossing and lamination process for embossing and joining multiple plies of tissue that can produce products having improved bulk and handfeel as well as a sufficient degree of ply attachment. Additionally, there remains a need in the art for a lamination process that is compatible with heating of the tissue ply during the embossing and lamination process that does not cause excessive elongation of the tissue or otherwise impede the embossing and lamination process.

### SUMMARY

The present invention provides a novel lamination process and laminated multi-ply tissue products produced thereby. The novel process and products do not rely upon an adhesive to join the multiple tissue plies together. Instead, the process utilizes an aqueous composition, such as water, and a heated embossing and lamination step to join the plies. Thus, in one aspect, the present invention provides an embossed multi-ply tissue product comprising two or more plies of tissue bonded together along adjacent surfaces of the two or more plies by a bonded area, wherein the bonded area is substantially free from an adhesive. In certain aspects the bonded area may correspond to embossments such that the tissue product comprises plies joined to one another at non-adhesively bonded embossed areas.

In other aspects, the present invention provides an embossed multi-ply tissue product comprising two or more tissue plies bonded together at a plurality of bonded areas along adjacent surfaces of the two or more plies, wherein the bonded areas are substantially free from an adhesive and the two or more plies have a ply attachment strength of at least about 6 gf. In certain aspects the plurality of bonded areas may be formed by a plurality of embossments and the embossments may comprise at least about 2% of a given tissue plie surface area, such as from about 2% to about 30%.

In another aspect, the present invention provides an embossed multi-ply tissue product comprising a first tissue ply and a second tissue ply arranged in facing relation to one another and bonded together at a plurality of bonded areas, wherein the bonded areas are substantially free from an adhesive. The embossed multi-ply tissue may exhibit a ply attachment strength of at least about 5 gf, such as at least about 6 gf, such as at least about 7 gf, such as from about 5 gf to about 15 gf, such as from about 5 gf to about 12 gf, as measured by the ply attachment strength test method described herein. In certain aspects the bonded areas may be formed by a plurality of embossments disposed on at least one of the tissue plies.

In still other aspects, the present invention provides a multi-ply tissue paper product comprising, two, three, four or more tissue plies, wherein at least two of the tissue plies are attached to one another by a plurality of embossments forming a plurality of bonding areas and wherein the plurality of bonding areas are substantially free from adhesive. In certain aspects one or more of the tissue plies may comprise a micro-embossing pattern and at least one of the plies comprises a décor embossing pattern.

In other aspects the present invention provides a method of manufacturing an embossed multi-ply tissue product comprising the steps of conveying a first tissue ply having a first surface; applying an aqueous composition to the first surface of the first tissue ply to yield a wetted tissue ply having a basis weight greater than the basis weight of the first tissue ply; providing an embossing unit comprising a first heatable embossing roll, a first counter roll and a marrying roll, wherein the first heatable embossing roll and first counter roll are arranged to form a first embossing nip therebetween and the first heatable embossing roll and marrying roll are arranged to form a second nip therebetween, the first embossing roll further comprises a plurality of male embossing elements arranged to form a first embossing pattern; conveying a wetted tissue ply into the first embossing nip to emboss the wetted tissue ply with the first embossing pattern and dry the wetted tissue thereby yielding an embossed tissue ply having a basis weight that is less than the basis weight of the wetted tissue ply; conveying the embossed tissue ply into the second nip; conveying a second tissue ply into the second nip; and joining the embossed tissue ply and the second tissue ply together in the second nip to form an embossed multi-ply tissue product wherein the first and second tissue plies are joined together at bonded areas substantially corresponding to the first embossing pattern and the bonded areas are free from adhesive.

In yet another aspect, the present invention provides a method for making an embossed multi-ply tissue product in which two or more plies of tissue are bonded to one another to form a multi-ply tissue without the application of an adhesive to any one of the tissue plies. For example, the process may comprise providing a first ply of tissue; providing a second ply of tissue; applying an aqueous composition to the first or the second tissue ply to yield a wetted tissue ply, wherein the aqueous composition add-on ranges from about 2 wt % to about 3 wt %, based upon the bone-dry weight of the first or second tissue ply; conveying the wetted tissue ply through an embossing nip formed by a heated embossing roll and a counter roll, wherein the surface temperature of the heated embossing roll ranges from about 90° C. to about 180° C.; and combining and marrying the first and second plies of tissue along adjacent surfaces of the first and second plies the two plies are joined together without an adhesive.

In certain aspects of the inventive lamination process the aqueous composition may be applied to the surface of tissue ply by rotogravure printing, flexographic printing, spraying, slot coating, blade coating or foam coating. In certain aspect the aqueous composition is added to the tissue ply immediately prior to embossing such that the wetted tissue ply does not have sufficient time to dry before being conveyed through the embossing nip. As the wetted tissue ply contacts the heated embossing roll the wetted tissue product may be dried and embossed in a single step. Drying of the wetted tissue ply may be carried out by heating the embossing roll having a surface temperature ranging from about 90° C. to 180° C., such as from about 100° C. to about 160° C.

In other aspects the present invention provides a method of manufacturing an embossed, laminated, multi-ply tissue product, comprising the steps of conveying a tissue ply, applying an aqueous composition to the tissue ply to increase the basis weight of the tissue ply from about 2 wt % to 3 wt % to yield a wetted tissue ply, conveying the wetted tissue ply through an embossing nip formed between a first counter roll and a first heatable embossing roll heated to a temperature ranging from about 90° C. to 180° C. to yield an embossed tissue ply to yield an embossed tissue ply; and laminating the embossed tissue ply to a second tissue ply by passing the embossed tissue ply and the second tissue ply through a nip formed between the first heatable embossing roll and a marrying roll.

In yet other aspects the present invention provides a method of manufacturing a multi-ply embossed tissue product, such as toilet paper or household towel, comprising the steps of conveying, a first tissue ply and a second tissue ply, the plies each having a basis weight ranging from about 14 to about 30 grams per square meter (gsm), applying an aqueous composition having a temperature ranging from about 50° C. to about 80° C. to at least the first tissue ply to increase the basis weight of the first tissue ply from 2 wt % to 3 wt % and yield a first wetted tissue ply, receiving the first wetted tissue ply in a first embossing nip formed between a first counter roll and a first heatable embossing roll heated to a temperature ranging from about 90° C. to 180° C. to yield a first embossed tissue ply, and laminating the first embossed tissue ply and the second tissue ply between the first heatable embossing roll and a marrying roll.

In still other aspects the present invention provides an apparatus for the manufacture of an embossed and laminated multi-poly tissue product, the apparatus comprising an applicator and embossing and lamination station. Preferably the applicator is configured for applying an aqueous composition to a first and/or a second tissue ply prior to conveying the first and/or second ply to the embossing and lamination station. Preferably the applicator comprises one or more wetting units configured to wet the first and/or second tissue plies.

### DESCRIPTION OF THE DRAWINGS

FIG. 1 is a schematic illustration of an embossing and lamination apparatus for manufacturing an embossed, multi-ply tissue product.

FIG. 2 is a schematic illustration of another embossing and lamination apparatus for manufacturing an embossed, multi-ply tissue product.

### DEFINITIONS

As used herein, the term “adhesive” generally refers to a chemical composition, particularly a polymeric chemical composition, capable of bonding two components (adhering) together. Examples of adhesives include a curable adhesive, a heat-activated adhesive, a pressure-sensitive adhesive, and the like. Common adhesives used to ply tissue plies together include polyvinyl alcohol, starch-based adhesives and methylcellulose adhesives.

As used herein, the term “substantially free” means less than 3 wt %, alternatively less than 2 wt %, alternatively less than 1 wt %, alternatively less than 0.5 wt %, alternatively less than 0.25 wt %, alternatively less than 0.1 wt %, alternatively less than 0.05 wt %, alternatively less than 0.01 wt %, and/or alternatively free of. As used herein, “free of” means 0 wt %.

As used herein, the term “aqueous composition” generally refers to a composition that is predominately water, more specifically a composition comprising at least about 97 wt % water and being substantially free from an adhesive. In certain preferred instances the aqueous composition is free from adhesive. In certain instances, the aqueous composition comprises at least about 98 wt % water, such as at least about 99 wt % water, such as at least about 99.5 wt % water.

As used herein the term “machine direction” or “MD” generally refers to the direction in which a tissue web or product is produced. The term “cross-machine direction” or “CD” refers to the direction perpendicular to the machine direction.

As used herein the term “basesheet” refers to a tissue web formed by any one of the papermaking processes described herein that has not been subjected to further processing, such as embossing, calendering, treatment with an aqueous composition, perforating, plying, folding, or rolling into individual rolled products.

As used herein the term “tissue product” refers to products made from basesheets and includes, bath tissues, facial tissues, paper towels, industrial wipers, foodservice wipers, napkins, medical pads, and other similar products.

As used herein the term “ply” refers to a discrete tissue web used to form a tissue product. Individual plies may be arranged in juxtaposition to each other. In a preferred embodiment, tissue products prepared according to the present invention comprise two or more plies arranged in facing relation to one another.

As used herein, the term “ply attachment strength” refers to the peak force, typically having units of grams (g), necessary to separate two plies of a tissue product. Ply attachment strength is measured as described in the Test Method section.

As used herein, the term “layer” refers to a plurality of strata of fibers, chemical treatments, or the like, within a ply. A “layered tissue web” generally refers to a tissue web formed from two or more layers of aqueous papermaking furnish. In certain instances, the aqueous papermaking furnish forming two or more of the layers comprises different fiber types.

As used herein, the term “décor embossing pattern” generally refers to a visually preservable pattern disposed on at least one of the outer most surfaces of the tissue product which is formed by one or more embossments which are imparted to the tissue product by embossing. As an example, the height of the embossments forming a décor embossing pattern may range from about 0.2 mm to about 1 mm, such as from about 0.4 mm to about 0.8 mm, such as from about 0.4 mm to about 0.7 mm. This corresponds to embossing tips (engraving) on the cylinder having an engraving height ranging from about 0.2 mm to about 2.2 mm, such as from about 0.5 mm to about 2.0 mm, such as from about 1.0 mm to about 2.0 mm.

As used herein, the term “pattern” refers to any non-random repeating design, figure, or motif. Generally, the fabrics described herein may comprise decorative patterns comprising a plurality of line elements and/or a plurality of recesses. However, it is not necessary that the line elements form recognizable shapes, and a repeating design of the line elements and/or recesses is considered to constitute a decorative pattern.

As used herein, the term “surface” when used in reference to basesheet, a tissue ply or a tissue product, means that portion of the sheet, ply or product that is exposed to the external environment. In other words, the surface of a sheet, ply or product is that portion of the sheet, ply or product that is not contacted by another sheet, ply or product.

As used herein, the term “user contacting surface” as used herein means that portion of the sheet, ply or product that is brought into contact with the user in-use. For example, it may be the surface of a tissue product that contacts the user's skin when a user wipes their skin with the product. In the case of an embossed sheet, ply or product prepared according to the present invention it may be the case that the embossed areas may not form a portion of the user contacting surface as they may have lower surfaces that lie below the upper most product surface which contacts the user in-use.

As used herein the term “basis weight” generally refers to the conditioned weight per unit area of a tissue and is generally expressed as grams per square meter (gsm) and is measured as described in the Test Methods section below. While the basis weights of tissue products prepared according to the present invention may vary, in certain embodiments the products have a total basis weight of about 30 gsm or greater, such as about 34 gsm or greater, such as about 36 gsm or greater, such as from about 30 to about 65 gsm, such as from about 32 to about 60 gsm, such as from about 38 to about 48 gsm.

As used herein, the term “caliper” refers to the thickness of a tissue product, web, sheet, or ply, typically having units of microns (μm) and is measured as described in the Test Methods section below.

As used herein, the term “sheet bulk” refers to the quotient of the caliper (μm) divided by the basis weight (gsm) and having units of cubic centimeters per gram (cc/g). Tissue products prepared according to the present invention may, in certain embodiments, have a sheet bulk of about 6.0 cc/g or greater, such as about 8.0 cc/g or greater, such as about 10.0 cc/g or greater, such as from about 6.0 to about 14.0 cc/g.

As used herein, the term “geometric mean slope” (GM Slope) generally refers to the square root of the product of machine direction slope and cross-machine direction slope. GM Slope generally is expressed in units of kg. Finished tissue products prepared according to the present disclosure generally have a GM slope of about 10 kg or less. In other aspects, the GM slope can be about 5.0 kg to about 10.0 kg or from about 8.0 kg to about 10.0 kg.

As used herein, the term “geometric mean tensile” (GMT) refers to the square root of the product of the machine direction tensile strength and the cross-machine direction tensile strength of the web. The GMT of tissue products prepared according to the present invention may vary, however, in certain instances the GMT may be about 800 g/3″ or greater, such as about 900 g/3″ or greater, such as about 1,000 g/3″ or greater, such as about 1,100 g/3″ or greater, such as about 1,200 g/3″ or greater, such as about 1,300 g/3″ or greater, such as about 1,400 g/3″ or greater, such as about 1,600 g/3″ or greater such as from about 800 to about 1,700 g/3″.

As used herein, the term “Stiffness Index” refers to the quotient of the geometric mean tensile slope, defined as the square root of the product of the MD and CD slopes (having units of kg), divided by the average geometric mean tensile strength (having units of grams per three inches) multiplied by 1000. While the Stiffness Index may vary, finished tissue products prepared according to the present disclosure generally have a Stiffness Index of about 10 or less, such as from about 7.0 to about 10.0, such as from about 8.0 to about 10.0.

Ranges can be expressed herein as from “about” one particular value and/or to “about” another particular value. When such a range is expressed, another aspect includes from the one particular value and/or to the other particular value. Similarly, when values are expressed as approximations, by use of the antecedent “about,” it will be understood that the particular value forms another aspect. It should be further understood that the endpoints of each of the ranges are significant both in relation to the other endpoint and independently of the other endpoint.

Similarly, when values are expressed as approximations, by use of the antecedent “about,” it will be understood that the particular value forms another aspect. It will be further understood that the endpoints of each of the ranges are significant both in relation to the other endpoint and independently of the other endpoint. Unless stated otherwise, the term “about” means within 5% (e.g., within 2% or 1%) of the particular value modified by the term “about.”

Throughout this disclosure, various aspects of the disclosure can be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, a description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

All percentages and ratios are calculated by weight unless otherwise indicated. All percentages and ratios are calculated based on the total composition unless otherwise indicated.

Unless otherwise noted, all component or composition levels are in reference to the active portion of that component or composition, and are exclusive of impurities, for example, residual solvents or by-products, which may be present in commercially available sources of such components or compositions.

### DESCRIPTION

It has now been discovered that embossed and laminated tissue products may be prepared in a simple, efficient process that combines lamination and embossing process into a single unit operation without the use of an adhesive. Additionally, the embossed and laminated tissue products prepared as described herein may have one more improved physical properties compared to adhesively laminated and embossed tissue products. For example, the clarity of the décor embossing pattern may be improved by wetting the tissue web prior to embossing and using a heated embossing apparatus to emboss and dry the wetted tissue ply as it is laminated to another tissue ply without the use of an adhesive.

Accordingly, in one particularly preferred embodiment, the products of the present invention are embossed and laminated by an embossing and lamination apparatus comprising a means for applying an aqueous composition to at least one of the tissue webs prior to the ply entering an embossing nip formed by a heated steel male embossing roll and an opposed counter roll and subsequent lamination to another tissue ply. This process is not only efficient means of carrying out both embossing and lamination but may reduce product stiffness, increase the caliper of the embossed tissue product, even at lower embossing nip loads, while preserving the integrity of the tissue web and reducing tensile degradation. In still other instances the process may yield embossed tissue products having improved décor embossing pattern clarity and improved ply attachment.

Individual tissue plies, also referred to herein as basesheet, may be any fibrous web suitable for embossing, including paper, tissue, nonwovens, films, laminates, combinations thereof and the like. In the case of tissue basesheet, which for purposes herein means basesheets intended for use as facial tissue, bath tissue, table napkins and paper towels, can be layered or nonlayered, creped or uncreped, wet pressed or throughdried, single-ply or two-ply or multi-ply, and can comprise natural and/or synthetic fibers.

The tissue products produced as described herein generally comprise two, three or four tissue plies made by well-known wet-laid papermaking processes such as, for example, creped wet pressed, modified wet pressed, creped through-air dried (CTAD) or uncreped through-air dried (UCTAD). For example, creped tissue webs may be formed using either a wet pressed or a modified wet pressed process such as those disclosed in U.S. Pat. Nos. 3,953,638, 5,324,575 and 6,080,279, the disclosures of which are incorporated herein in a manner consistent with the instant application. In these processes the embryonic tissue web is transferred to a Yankee dryer, which completes the drying process, and then creped from the Yankee surface using a doctor blade or other suitable device.

In other instances, the tissue basesheet may be manufactured by a through-air dried process known in the art. In such processes the embryonic web is noncompressively dried. For example, textured tissue plies may be formed by either creped or uncreped through-air dried processes. Particularly preferred are uncreped through-air dried webs, such as those described in U.S. Pat. No. 5,779,860, the contents of which are incorporated herein in a manner consistent with the present disclosure.

In still other instances individual tissue plies may be manufactured by a process including the step of using pressure, vacuum, or air flow through the wet web (or a combination of these) to conform the wet web into a shaped fabric and subsequently drying the shaped sheet using a Yankee dryer, or series of steam heated dryers, or some other means, including but not limited to tissue made using the ATMOS process developed by Voith or the NTT process developed by Metso; or fabric creped tissue, made using a process including the step of transferring the wet web from a carrying surface (belt, fabric, felt, or roll) moving at one speed to a fabric moving at a slower speed (at least 5 percent slower) and subsequently drying the sheet. Those skilled in the art will recognize that these processes are not mutually exclusive, e.g., an uncreped TAD process may include a fabric crepe step in the process.

The multi-ply embossed tissue products of the present invention generally have a total product basis weight of at least about 20 gsm, such as at least about 30 gsm, such as at least about 35 gsm, such as at least about 40 gsm, such as at least about 45 gsm. In certain instances, the product basis weight may range from about 20 gsm to about 70 gsm, such as from about 30 gsm to about 65 gsm, such as about 40 gsm to about 60 gsm. In certain instances, the multi-ply embossed tissue products may comprise two, three or four tissue plies where the basis weight of each individual tissue plie is less than about 25 gsm, such as from about 10 gsm to about 25 gsm, such as from about 10 gsm to about 20 gsm.

The multi-ply embossed tissue products of the present invention generally have a geometric mean tensile (GMT) of about 800 g/3″ or greater, such as about 900 g/3″ or greater, such as about 1,000 g/3″ or greater, such as about 1,100 g/3″ or greater, such as about 1,200 g/3″ or greater, such as about 1,300 g/3″ or greater, such as about 1,400 g/3″ or greater, such as about 1,600 g/3″ or greater. In certain instances, the GMT may range from about 800 g/3″ to about 1,700 g/3″, such as from about 900 g/3″ to about 1,600 g/3″, such as from about 1,000 g/3″ to about 1,500 g/3″. In certain instances, the multi-ply embossed tissue products may comprise two, three, or four tissue plies where the GMT of each individual tissue plie is less than about 600 g/3″, such as from about 200 g/3″ to about 425 g/3″, such as from about 350 g/3″ to about 550 g/3″.

At the foregoing tensile strengths, the multi-ply tissue products of the present invention may have a Stiffness Index of about 10.0 or less, such as from about 7.0 to about 10.0, such as from about 8.0 to about 10.0. For example, the present invention provides multi-ply rolled bath tissue products comprising two or more embossed tissue plies laminated to one another without the use of an adhesive, where the product has a GMT from about 1,000 g/3″ to about 1,500 g/3″ and a Stiffness Index from about 8.0 to about 10.0. The absence of an adhesive generally yields a product that is less stiff and more flexible compared to similar products produced using an adhesive to join the sheets together.

In other instances, the multi-ply embossed tissue products of the present invention may have a sheet bulk greater than about 6.0 cc/g, such as from about 6.0 to about 14.0 cc/g. In certain instances, at the foregoing sheet bulks, the tissue products may have a sheet caliper greater than about 300 μm, such as greater than about 400 μm, such as greater than about 500 μm, such as greater than about 600 μm, such as from about 300 to about 1,000 μm.

Generally, the multi-ply products of the present invention are embossed and comprise two or more tissue plies bonded together along a plurality of bonded areas. In certain instances, the bonded areas may correspond to the embossments disposed on the one or more tissue plies. The bonded areas are generally substantially free from adhesives, and more preferably free from adhesives. The embossed area, relative to the total area of the ply surface, and in-turn the bonded area, may range from about 2% to about 50%, such as from about 2% to about 30%, such as form about 2% to about 20%. The amount of surface area occupied by the décor embossing pattern may be by delineating the perimeter of the décor embossing pattern, which may be known by those of skill in the art as the “footprint” subtended by the periphery of embossing pattern.

In certain instances, it may be desirable to reduce the total embossed area, without sacrificing ply attachment, such that the total embossed surface area ranges from about 2% to about 20%, such as from about 2% to about 10%, such as from about 3% to about 8%, yet having a ply attachment strength of at least about 6 gf, such as from about 6 gf to about 12 gf. Without desiring to be bound by theory, providing a tissue product having an embossed area less than about 20% and still more preferably less than about 10% and a décor embossing pattern comprising open, curvilinear elements, particularly a curvilinear line element formed from a plurality of dot emboss elements communicates to the consumer that the product is soft and cushiony while providing good ply attachment, even without the use of an adhesive.

The presence of bonded areas between plies of the multi-ply products provides the products with a certain degree of ply attachment, which may be measured according to the ply attachment strength test method described herein. Surprisingly, the multi-ply tissue products of the present invention achieve a relatively high degree of ply attachment without use of adhesive. For example, the multi-ply tissue products may have a ply attachment strength of at least about 5 gf, such as at least about 6 gf, such as at least about 7 gf, such as from about 5 gf to about 15 gf, such as from about 5 gf to about 12 gf.

The foregoing multi-ply tissue products may be converted into rolled tissue products, such as rolled bath tissue products, comprising a multi-ply embossed tissue web spirally wound about a core. Such rolled tissue products may comprise a plurality of connected, but perforated, multi-ply tissue sheets that may be separated from adjacent sheets.

To produce multi-ply tissue products, individual tissue plies are prepared and then combined using well known processing machines (converting machines) which include operations such as unwinding the base tissue sheets, calendering, printing, embossing, lamination of individual plies, as well as cutting, perforation and folding. An embossing process is carried out in the nip between an embossing roll, also referred to herein as a patterned roll, and an anvil roll, also referred to herein as a counter roll. The embossing roll can have protrusions on its circumferential surface leading to embossments in the resulting embossed tissue ply.

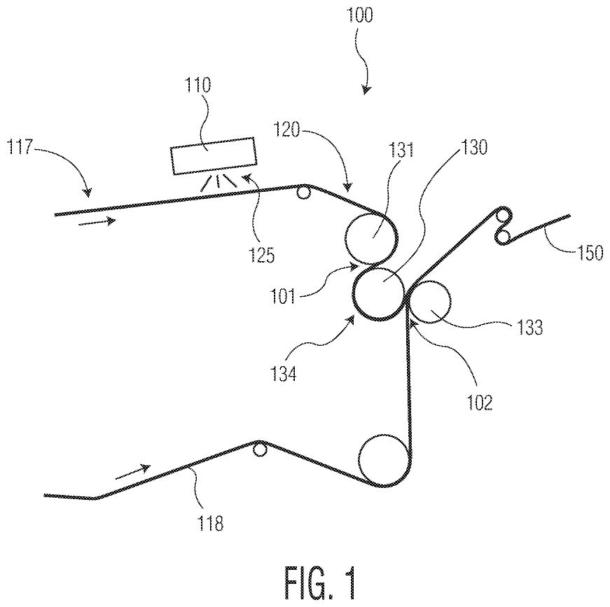

One process for producing an embossed and laminated tissue product according to the present invention is illustrated in FIG. 1. When the embossing-laminating device 100 is operating the first tissue ply 117 and the second tissue ply 118 move according to the arrows. The first tissue ply 117 moves past an applicator 110 and toward a first nip 101 formed between the patterned roll 130 and opposed anvil roll 130. Generally, the first nip 101 forms an embossing nip at which an embossing pattern is imparted to the wetted tissue ply 120 as it passes through the nip 101. In certain instances, the patterned roll may comprise a plurality of male embossing elements that extend from the surface of the embossing roll surface a height, generally measured from a plane normal to the surface of the embossing roll, of less than about 1.00 mm and more preferably less than about 0.80 mm, such as from about 0.50 to about 1.00 mm.

After exiting the first nip 101, the embossed ply 134 is laminated with the second tissue ply 118 in a second nip 102 formed between the patterned roll 130 and the marrying roll 133. The pressure applied to the plies 118, 134 in the second nip 102 bonds the plies 118, 134 together to form a multi-ply tissue product 150 without the use of an adhesive.

The applicator 110 may be configured to apply an aqueous composition 125 by spraying onto a first outer surface 119 of the first tissue ply 117 to yield a wetted tissue ply 120, which is subsequently conveyed to towards the first nip 101 without drying. In one example, once the wetted tissue ply 120 is conveyed through the first embossing nip 101, which is a heated nip as a result of the pattern roll 131 being heated, the wetted tissue ply 120 is simultaneously at least partially dried and embossed. The embossed and at least partially dried tissue web 134 may then be conveyed to the second nip 102 and laminated with a second tissue web 118, which may or not be embossed, without the addition of an adhesive.

The aqueous composition may be applied to a surface of the first outer surface of the first tissue ply by any suitable means known in the art. Any contact or contactless application means suitable for applying an aqueous composition to a tissue ply, such as spraying, dipping, padding, printing, slot extruding, rotogravure printing, flexographic printing, offset printing, screen printing, mask or stencil application process and mixtures thereof can be used to apply the aqueous composition to the first outer surface of the first tissue ply prior to embossing.

In certain aspects non-contact printing methods such as ink jet printing, digital printing, spraying, and topical application using a WEKO fluid application system (commercially available from Weitmann & Konrad GmbH & Co., Leinfelden-Echterdingen, Germany) may be used to apply the aqueous composition to the web prior to embossing. In certain preferred embodiments the aqueous composition is applied without direct contact between the ply and the applicator, such as by a liquid applicator comprising a nozzle system to spray the aqueous composition onto the outer surface of the tissue ply as it is conveyed past the applicator. In certain embodiments, it may be preferable to configure the liquid applicators such that they wet the surface of the tissue ply will be brought into contact with the male embossing roll later in the embossing process and subsequently form the user contacting surface of the resulting tissue product.

The aqueous composition can be applied by a single device of multiple devices may be configured to apply the aqueous composition to the tissue ply. The one or more application devices may apply the same aqueous composition or may be configured to apply different aqueous compositions. In those instances where the process employs a single device it may be configured to apply two or more different aqueous compositions by providing the device with two or more chambers capable of separately delivering the different compositions.

Wetted tissue ply may be the first or the second tissue ply. In other instances, both a first and a second tissue ply may be wetted prior to being embossed. The same aqueous composition may be configured to treat both the first and the second tissue ply or the separate applicator units may be used to treat the first and the second tissue plies with different aqueous compositions.

Regardless of the type of applicator and whether there are one or more applicators the applicator may be configured and arranged to apply an aqueous composition to the one or more tissue plies immediately prior to the one or more plies being conveyed to an embossing unit or may be configured to apply the aqueous composition while the ply is engaged by one of the embossing rolls. Regardless, it is generally preferred that the wetted ply does not have sufficient time to dry before embossments are imparted to the web by the heated embossing roll.

In certain instances, the applicator unit may be configured to apply the aqueous composition to only a portion of the tissue ply surface. For example, in certain instances the applicator may be configured such that only the embossed portion of the ply is treated. In other instances, the applicator unit may be configured such that the aqueous composition covers at least about 90% of the surface area of the tissue ply, such as at least about 92%, such as at least about 95%, such as about 100%. Further, the aqueous composition may be applied in a pattern or may be applied randomly.

The applicator unit may be configured to provide a controlled amount of aqueous composition the tissue ply such that the basis weight of the tissue ply is increased in the range from about 1% to about 5% of the basis weight of the tissue ply, such as from about 2% to about 3%. Preferably the wetted tissue ply is dried as it is brought into contact with the heated embossing roll. In this manner, the embossed tissue ply may have a basis weight substantially similar to the unembossed tissue ply prior to application of the aqueous composition.

In certain instances, it may be desirable to heat the aqueous composition prior to wetting of the tissue ply. In this manner the temperature of the aqueous composition being applied to the tissue ply may be about 50° C. or greater, such as about 55° C. or greater, such as about 60° C. or greater, such as about 65° C. or greater, such as about 70° C. or greater. In certain instances, the temperature of the aqueous composition may range from about 50° C. to about 80° C., such as from about 60° C. to about 75° C., about 65° C. to about 70° C.

With continued reference to FIG. 1, a first tissue ply 117 and a second tissue ply 118 are conveyed separately. The first tissue ply 117, having a first upper surface 119, may be conveyed past an applicator 110. The applicator 110 is configured to apply an aqueous composition 125 to the first upper surface 119 of the first tissue ply 117 to yield a wetted tissue ply 120. The application of the aqueous composition 125 causes the basis weight of the first tissue ply 117 to increase such that the basis weight of the wetted tissue ply 120 is greater than the basis weight of the first tissue ply 117. While the embodiment illustrated in FIG. 1 comprises a single applicator, the apparatus may comprise more than one applicator and the one or more applicators may be configured to apply an aqueous composition to the first and/or second tissue ply.

The wetted tissue ply 120 is conveyed to an embossing nip 101, which is preferably heated, where the wetted tissue ply 120 is embossed and at least partially dried to yield an embossed and at least partially dried tissue ply that may be combined with a second ply 118 to form a multi-ply embossed tissue product 150. The embossing nip 101 may be formed between a heated patterned roll 130 and an opposed anvil roll 131.

The pattern roll generally comprises a heating means for heating the pattern roll, particularly the outermost surface of the pattern roll which is brought into contact with the wetted tissue ply as it passes through the embossing nip. The heating means preferably heats embossing roll, particularly the outermost surface of the embossing roll, to a temperature of about 80° C. or greater, such as about 90° C. or more, still more preferably about 100° C. or more, such as from about 80° C. to about 200° C., such as from about 100° C. to about 180° C. The heating means may be either housed within the embossing roll for heating by conduction or housed outside the roll and facing the surface of the roll for heating by radiation and/or convection.

In certain aspects the wetted tissue ply remains in contact with the heated embossing roll for a sufficiently long time to at least partially dry the wetted tissue ply, but without reducing the processing speed of the tissue product. The duration of contact between the wetted tissue ply and the embossing roll may be reduced by limiting the amount of aqueous composition added to the ply, such as about 3 wt % or less and by heating the aqueous composition prior to addition. The duration of contact, however, will be further influenced by the temperature of the embossing roll, the size of the roll and the degree to which the wetted tissue ply wraps the roll. Generally, it is preferred to optimize the conditions not only to improve embossing clarity and lamination, measured as interplay attachment, but also to maintain sufficient processing speed and maintaining the efficiency of the drying process of the embossed wet tissue ply.

After the first tissue ply is embossed, it is laminated to a second tissue ply to form a multi-ply tissue product. The lamination process is carried out without the use of an adhesive. Instead, an aqueous competition, preferably free from any adhesives, is applied just prior to the lamination step such that the ply does not prematurely dry prior to being joined with the second ply. In this manner it may be preferable that the aqueous composition is applied to the first ply immediately prior to, or while, the first ply is brought into contacted with the heated embossing roll and then joined to the second ply in a second nip formed between the heated embossing roll and a marrying roll.

Accordingly, in certain embodiments the joining station may be configured such that the upper steel embossing roll abuts an aqueous composition delivery assembly and a marrying roll to further laminate and join the first embossed ply to the second ply to form a multi-ply embossed tissue product according to the present invention. In particular, the upper steel embossing roll may abut an aqueous composition delivery applicator which distributes an aqueous composition onto the embossed ply, particularly the protruding embossments of the embossed ply. After application of the aqueous composition the embossed and wetted ply (or partially dried ply) may be joined to the second ply by a marrying roll, which may be arranged such that it abuts the upper steel embossing roll. In this manner, the upper steel embossing roll and marrying roll may form a nip therebetween through which the plies pass and are joined together to form a multi-ply tissue product without the use of an adhesive.

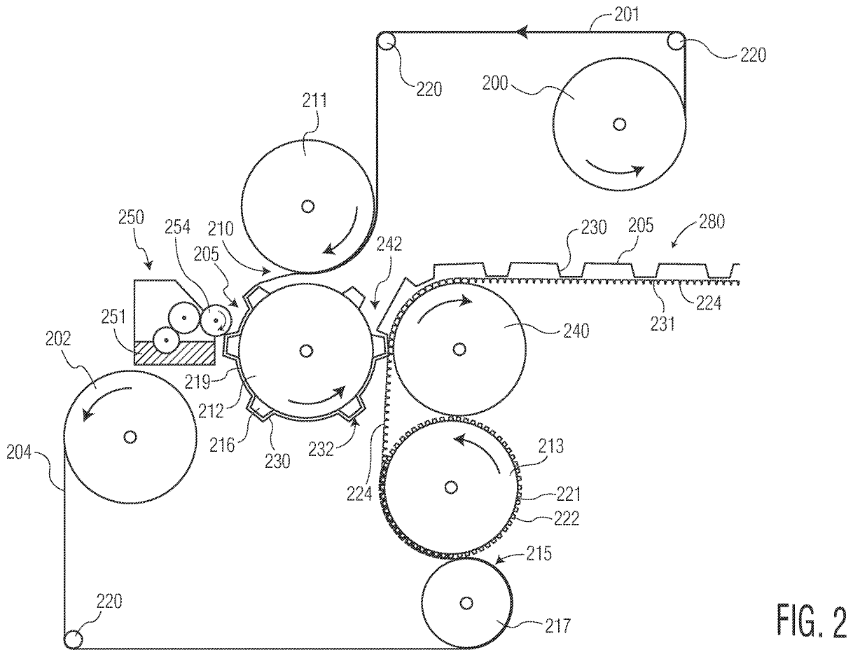

Another apparatus for embossing and lamination useful in the present invention is shown in FIG. 2. A first tissue ply 201 is unwound from a first parent roll 200 and conveyed to a first embossing unit. The first embossing unit comprises a first impression roll 211 and a first embossing roll 212, which are urged together to form a first embossing nip 210 through which the first tissue ply 201 passes to impose a first embossing pattern thereon, which in certain preferred embodiments may be a décor embossing pattern. Generally, a force or pressure is applied to one or both of the rolls such that the rolls are urged against one another causing the impression roll to deform about the protuberances such that when the ply is pressed about the protuberances and onto the landing areas (i.e., the outer surface areas of the roll surrounding the protuberances) an embossment results. As the embossed first tissue ply 205 exits the first embossing nip 210 it comprises a plurality of embossments 230 having distal ends 232.

After exiting the first embossing nip 210 the first embossed ply 205 encounters a wetting unit 250, which comprises an aqueous composition 251 disposed in a reservoir and an applicator roll 252. An aqueous composition 251 is transferred to the applicator roll 252 and applied to the distal ends 232 of the embossments 230 that are formed on the exterior surface of the embossed first tissue ply 205 by virtue of contact with the first protuberances 216.

In the embodiment illustrated in FIG. 3, the aqueous composition 251 is contained within a bath 250 and is initially applied to the applicator roll 252 via one or more rolls. The applicator roll 252 may comprise any suitable roll or surface capable of transferring an aqueous composition onto the surface of the tissue ply. The applicator roll, for instance, may be substantially smooth, such as a chrome plated steel roll, a ceramic roll, or a rubber-coated roll. In one embodiment, the applicator roll comprises an anilox roll that may be engraved and textured. For instance, the applicator roll may comprise a gravure roll having a surface covered with recessed cells that hold the aqueous composition due to capillary action.

The way the aqueous composition is applied to the applicator roll can vary depending upon the particular application. In the embodiment illustrated in FIG. 3, for instance, the aqueous composition 251 is contained in a bath 250 and transferred to the applicator roll 252 via a series of counter rotating rolls. In an alternative embodiment, the process may include a flooded nip between an applicator roll and a counter rotating roll. A pool of the aqueous composition is maintained within the flooded nip for application to the applicator roll.

In other embodiments, the applicator roll may be at least partially enclosed within a chamber. The aqueous composition can be applied to the applicator roll within the chamber by flowing the composition onto the roll, by extruding the composition onto the roll, or by spraying the composition onto the roll. If desired, one or more blades may be placed adjacent to the applicator roll for maintaining the proper amount of aqueous composition on the applicator roll prior to contact with the patterned roll.

In certain embodiments the applicator may comprise a metering roll comprising a plurality of individual cells, such as a gravure roll, and a transfer roll. The metering roll is in fluid communication with a reservoir, such as a chamber doctor blade reservoir, which is supplied with the aqueous composition. Upon axial rotation, the metering roll acquires the aqueous composition from the reservoir, which may precisely fill in the individual cells of the metering roll. The metering roll then transfers a particular quantity of the aqueous composition to the transfer roll. The transfer roll then transfers the aqueous composition tissue ply.

The aqueous composition is preferably applied to the applicator roll at an elevated temperature. For instance, the aqueous composition may be heated the aqueous composition may be heated to a temperature of about 50° C. or greater, such as about 55° C. or greater, such as about 60° C. or greater, such as about 65° C. or greater, such as about 70° C. or greater. In certain instances, the temperature of the aqueous composition may range from about 50° C. to about 80° C., such as from about 60° C. to about 75° C., about 65° C. to about 70° C. The aqueous composition can be heated using any suitable heating device, such as an infrared heater, an electrical resistance heater, a gas heater or the like.

With continued reference to FIG. 2, the aqueous composition 251 is transferred from the surface the applicator roll 252 to the surface of the embossed ply 205, particularly the distal ends 232 of the embossments 230 as they are supported by, and in contact with, the first protuberances 216. The amount of aqueous composition applied to the patterned roll 252 and subsequently the embossed tissue ply 205 may depend upon various factors, including the roll speeds, the viscosity of the aqueous composition, the application rate, and any particular pattern present on the applicator roll 252.

The embossed first tissue ply 205 with the applied aqueous composition 251 then advances further to the third nip 242 between the first engraved embossing roll 212 and the marrying roll 240. At this point, the embossed second ply 224 is attached to the embossed first ply 205 and then conveyed through the third nip 242 to form a laminated two-ply tissue product 280 which is subsequently wound into a roll (not shown).

To form a two-ply tissue product, a second parent roll 202 is unwound and the second tissue ply 204 is conveyed around an idler roller 220 and is then passed into a second embossing nip 215 formed between a second impression roll 217 and a second engraved embossing roll 213. The second impression roll generally has a smooth outer surface, which may be deformable. In certain instances, the second impression roll has an outer covering comprising a natural or synthetic rubber and may have a hardness greater than about 40 Shore (A), such as from about 40 to about 100 Shore (A). The second engraved embossing roll 213 generally comprises a plurality of protuberances 222 extending from its peripheral surface 221. The protuberances are generally in the form of a second embossing pattern. In certain embodiments the protuberances disposed on the second engraved embossing roll may have a height of at least about 0.4 mm, such as from about 0.4 to about 2.0 mm.

As the second ply 204 passes through the second embossing nip 215 it is imparted with a plurality of emboss elements 231, which may be arranged to form a pattern. The embossed second ply 224 is then conveyed and brought into facing relation with the embossed first ply 205 using a marrying roll 240, as will be described in more detail below. While in certain instances the second engraved embossing roll 213 and impression roll 217 may be arranged relatively close to the first pair of rolls 211, 212 and the marrying roll 240, this is not necessary as the present method does not relying upon registration of the first and second embossing patterns with one another. In this manner, the present method differs from so called nested method embossing, such as that described in U.S. Publ. No. 20120156447, where the embossing elements of the first embossing roll and the embossing elements of the second embossing roll are arranged such that the embossed elements of the first embossed ply and the embossed elements of the second embossed ply fit into each other similar to a gearing system.

After the embossed second ply 224 leaves the second embossing nip 215 it is brought into facing relationship with the wetted and embossed first ply 205. The two embossed plies 205, 224 are conveyed through a third nip 242 formed between the first engraved embossing roll 212 and a marrying roll 240, which may be a steel roll having a substantially smooth outer surface. The first and second embossed plies 205, 224 are joined together as they pass through the third nip 242 to form a multi-ply tissue product 280.

### Test Methods

Unless otherwise specified, all tests described herein including those described under the Definitions section and the following test methods are conducted on samples that have been conditioned in a conditioned room at a temperature of 23° C.±1° C. and a relative humidity of 50%±2% for a minimum of 2 hours prior to the test. All plastic and paper board packaging articles of manufacture must be carefully removed from the paper samples prior to testing. The samples tested are “usable units.” “Usable units” as used herein means sheets, flats from roll stock, pre-converted flats, and/or single or multi-ply products. Except where noted all tests are conducted in such conditioned room, all tests are conducted under the same environmental conditions and in such conditioned room. Discard any damaged product. Do not test samples that have defects such as wrinkles, tears, holes, and like. Samples conditioned as described herein are considered dry samples for testing purposes. All instruments are calibrated according to manufacturer's specifications.

### Ply Attachment Strength

Ply attachment strength is measured using a SP-2100 Slip/Peel Tester (IMASS, Inc. Strongsville, OH) having a servo/screw drive capable of producing speeds ranging from 0.2 to 300 in/min (0.5 to 762 cm/min) and a 25 lbf (10 kgf) force. The test equipment platen travel rate is set at 28.0 inches per minute. The SP-2100 Slip/Peel Tester measures the Kinetic peak force it takes to separate two bonded tissue plies from one another. Bath tissue samples are generally prepared by separating individual sheets along the perforations, taking care not to damage, tear or compress the sample. Generally, the ply attachment strength of the individual bath tissue sheets is evaluated without cutting of individual samples to size. If, however, the sample exceeds 4 inches by 4 inches, the sample is cut to a size of 4 inches by 4 inches +/−0.25 inches prior to testing. For each sample, the plies are separated by hand for a distance of approximately 15 mm from the perforated edge to create two free sample ends that may be clamped into the test apparatus. The test sample is secured to the test apparatus using the provided clamp clips. The sample is preloaded by adjusting the manual positioning knob until the display reads 2±0.5 grams. The test is then commenced by activating the test apparatus. Generally, plies of the laminate are manually separated for a distance of about 2 inches along the length of the specimen. When the carriage stops and the average Kinetic Peak (i.e., peak load) needed to completely separate the plies from one another is recorded to the 0.1 gram. Samples having more than two plies are tested by placing one outer ply in the specimen clip and the other plies in the hold down device.

### Basis Weight

For dry tissue samples, such as embossed tissue products prepared according to the present invention, basis weight is measured by first conditioning the sample as described above. Thereafter, the basis weight of conditioned sample is measured by selecting twelve (12) products (also referred to as sheets) of the sample and making two (2) stacks of six (6) sheets. In the event the sample consists of perforated sheets of bath or towel tissue, the perforations must be aligned on the same side when stacking the usable units. A precision cutter is used to out each stack into exactly 10.16×10.16 cm (4.0×4.0 inch) squares. The two stacks of cut squares are combined to make a basis weight pad of twelve (12) squares thick. The basis weight pad is then weighed on a top loading balance with a minimum resolution of 0.01 grams. The top loading balance must be protected from air drafts and other disturbances using a draft shield. Weights are recorded when the readings on the top loading balance become constant. The mass of the sample (grams) per unit area (square meters) is calculated and reported as the basis weight, having units of grams per square meter (gsm).

For treated tissue products tissue products prepared according to the present invention, which may have not been subjected to drying after application of an aqueous composition, basis weight is measured as-is. Samples are collected and stored in a sealable bag until testing. Samples are removed from the sealed bag and thereafter stacked, cut and the weight measured as described above,

### Caliper

Caliper is measured in accordance with TAPPI test methods Test Method T 580 μm-12 “Thickness (caliper) of towel, tissue, napkin and facial products.” The micrometer used for carrying out caliper measurements is an Emveco 200-A Tissue Caliper Tester (Emveco, Inc., Newberg, OR). The micrometer has a load of 2 kilo-Pascals, a pressure foot area of 2,500 square millimeters, a pressure foot diameter of 56.42 millimeters, a dwell time of 3 seconds and a lowering rate of 0.8 millimeters per second.

### Tensile

Tensile testing is conducted on a tensile testing machine maintaining a constant rate of elongation and the width of each specimen tested is 3 inches. Testing is conducted under TAPPI conditions. Prior to testing samples are conditioned and then cut a 3±0.05 inches (76.2±1.3 mm) wide strip in either the machine direction (MD) or cross-machine direction (CD) orientation using a JDC Precision Sample Cutter (Thwing-Albert Instrument Company, Philadelphia, PA, Model No. JDC 3-10, Serial No. 37333) or equivalent. The instrument used for measuring tensile strengths was an MTS Systems Sintech 11S, Serial No. 6233. The data acquisition software was MTS TestWorks® for Windows Ver. 3.10 (MTS Systems Corp., Research Triangle Park, NC). The load cell was selected from either a 50 Newton or 100 Newton maximum, depending on the strength of the sample being tested, such that the majority of peak load values fall between 10 to 90 percent of the load cell's full-scale value. The gauge length between jaws was 4±0.04 inches (101.6±1 mm) for facial tissue and towels and 2±0.02 inches (50.8±0.5 mm) for bath tissue. The crosshead speed was 10±0.4 inches/min (254±1 mm/min), and the break sensitivity was set at 65 percent. The sample was placed in the jaws of the instrument, centered both vertically and horizontally. The test was then started and ended when the specimen broke. The peak load was recorded as either the “MD tensile strength” or the “CD tensile strength” of the specimen depending on direction of the sample being tested. Ten representative specimens were tested for each product or sheet and the arithmetic average of all individual specimen tests was recorded as the appropriate MD or CD tensile strength having units of grams per three inches (g/3″). Tensile energy absorbed (TEA) and slope are also calculated by the tensile tester. TEA is reported in units of g·cm/cm² and slope is recorded in units of kilograms (kg). Both TEA and Slope are directionally dependent and thus MD and CD directions are measured independently.

All products were tested in their product forms without separating into individual plies. For example, a 2-ply product was tested as two plies and recorded as such. In the tensile properties of basesheets were measured, the number of plies used varied depending on the intended end use. For example, if the basesheet was intended to be used for 2-ply product, two plies of basesheet were combined and tested.

### EXAMPLE

A two-ply laminated and embossed tissue product was produced substantially as illustrated in FIG. 3. Each ply consisted of conventional creped, wet-pressed, tissue web having a basis weight of about 19 grams pers square meter and comprising 80% eucalyptus hardwood kraft pulp and 20% northern softwood kraft pulp. Water or adhesive (Henkle™ 1090) were applied, as described in the table below, using an anilox roll having a capacity of 12 cc.

| | Em- | | | Heated | Ply |
|---|---|---|---|---|---|
| | bossing | Marrying | | Em- | Attachment |
| | Nip Load | Nip Load | Additive | bossing | Strength |
| Code | (kg/cm) | (kg/cm) | (% Solids) | Roll | (gf) |
| 1 | 20 | 10 | Adhesive (1%) | N | 4.59 |
| 2 | 20 | 4 | Adhesive (1%) | N | 3.67 |
| 3 | 20 | 3 | Adhesive (5%) | N | 15.29 |
| 4 | 18 | 8 | Water | N | 3.62 |
| 5 | 24 | 8 | Water | N | 4.44 |
| 6 | 20 | 6 | Water | Y | 7.44 |
| 7 | 25 | 6 | Water | Y | 7.54 |

Additional inventive codes were produced using relatively light marrying roll pressure (3 kg/cm) to determine whether sufficient ply attachment strength code be achieved without sacrificing other important product properties. A two-ply laminated and embossed tissue product was produced substantially as illustrated in FIG. 1. Each ply consisted of conventional creped, wet-pressed, tissue web having a basis weight of about 19 grams pers square meter and comprising 80% eucalyptus hardwood kraft pulp and 20% northern softwood kraft pulp. Plies attachment was facilitated by the addition of water or adhesive (Henkle™ 1090). In those instances where water was added it was applied using a Weko™ fluid application system at an addition of 2 wt %. The process conditions and physical properties of the resulting 2-ply laminated bath tissue products are shown in the tables below.

| | Embossing | Marrying | | Heated | Ply Attachment | |
|---|---|---|---|---|---|---|
| | Nip Load | Nip Load | Additive | Embossing | Strength | Caliper |
| Code | (kg/cm) | (kg/cm) | (% Solids) | Roll | (gf) | (microns) |
| 8 | 20 | 4 | Adhesive (1%) | N | 5.56 | 2160 |
| 9 | 20 | 3 | Water | Y | 7.52 | 2496 |
| 10 | 22 | 3 | Water | Y | 7.13 | 2489 |
| 11 | 20 | 3 | Water | Y | 8.56 | 2463 |
| 12 | 22 | 3 | Water | Y | 8.59 | 2471 |

1. A method of manufacturing an embossed multi-ply tissue product comprising the steps of:
a. conveying a first tissue ply having a first surface;
b. applying an aqueous composition to the first surface of the first tissue ply to yield a wetted tissue ply such that the basis weight of the wetted tissue ply is from about 1% to about 10% greater than the first tissue ply;
c. providing an embossing unit comprising a first heatable embossing roll, a first counter roll and a marrying roll, wherein the first heatable embossing roll and first counter roll are arranged to form a first embossing nip therebetween and the first heatable embossing roll and marrying roll are arranged to form a second nip therebetween, the first embossing roll further comprises a plurality of male embossing elements arranged to form a first embossing pattern;
d. conveying a wetted tissue ply into the first embossing nip to emboss the wetted tissue ply with the first embossing pattern and dry the wetted tissue thereby yielding an embossed tissue ply having a basis weight that is less than the basis weight of the wetted tissue ply;
e. conveying the embossed tissue ply into the second nip;
f. conveying a second tissue ply into the second nip; and
g. joining the embossed tissue ply and the second tissue ply together in the second nip to form an embossed multi-ply tissue product wherein the first and second tissue plies are joined together at bonded areas substantially corresponding to the first embossing pattern and the bonded areas are free from adhesive.

2. (canceled)

3. The method of claim 1 wherein either the first or the second tissue plies are micro-embossed prior to being conveyed into the second nip.

4. The method of claim 1 wherein the aqueous composition comprises at least about 99 wt % water.

5. The method of claim 1 wherein the aqueous composition is heated to at least 70° C.

6. The method of claim 1 wherein the first heatable embossing roll is configured to be heated to a temperature ranging from 80° C. to 180° C.

7. The method of claim 1 wherein the step of applying an aqueous composition is carried out by a spray applicator positioned to apply the aqueous composition before the first ply is conveyed into the first embossing nip.

8. The method of claim 6 wherein the spray applicator comprises a nozzle and a reservoir for receiving and storing the aqueous composition.

9. The method of claim 1 wherein the amount of aqueous composition applied to the first tissue ply ranges from about 2 wt % to about 3 wt % based upon the dry weight of the first tissue ply.

10. The method of claim 1 wherein the aqueous composition is applied to at least about 90% of the surface area of the first tissue ply.

11. The method of claim 10 wherein the aqueous composition is applied in a pattern.

12. The method of claim 1 wherein the first tissue ply is substantially dried after being conveyed through the second nip.

13. The method of claim 10 wherein the temperature of the aqueous composition ranges from about 60° C. to about 75° C.

14. A method of manufacturing an embossed multi-ply tissue product comprising the steps of:
a. providing an embossing unit comprising a first heatable embossing roll, a first counter roll and a marrying roll, wherein the first heatable embossing roll and first counter roll are arranged to form a first embossing nip therebetween and the first heatable embossing roll and marrying roll are arranged to form a second nip therebetween, the first embossing roll further comprises a plurality of male embossing elements arranged to form a first embossing pattern;
b. providing an applicator comprising a reservoir for receiving an aqueous composition and an applicator roll, wherein the applicator roll is disposed in opposition to both reservoir and the first heatable embossing roll;
c. conveying a first tissue ply having a first surface into the first embossing nip to emboss the first tissue ply;
d. contacting the first surface of the first tissue ply with the applicator roll to apply the aqueous composition thereto to yield a wetted tissue ply such that the basis weight of the wetted tissue ply is from about 1% to about 10% greater than the first tissue ply;
e. conveying the wetted tissue ply into the second nip;
f. conveying a second tissue ply into the second nip; and
g. joining the embossed tissue ply and the second tissue ply together in the second nip to form an embossed multi-ply tissue product wherein the first and second tissue plies are joined together at bonded areas substantially corresponding to the first embossing pattern and the bonded areas are free from adhesive.

15. The method of claim 14 wherein the aqueous composition comprises at least about 99 wt % water.

16. The method of claim 14 wherein the aqueous composition is heated to at least 70° C.

17. The method of claim 14 wherein the first heatable embossing roll is configured to be heated to a temperature ranging from 80° C. to 180° C.

18. The method of claim 14 wherein the amount of aqueous composition applied to the first tissue ply ranges from about 2 wt % to about 3 wt % based upon the dry weight of the first tissue ply.

19. The method of claim 18 wherein the aqueous composition is applied in a pattern.

20. The method of claim 14 wherein the first tissue ply is substantially dried after being conveyed through the second nip.
